(19) United States
(12) Patent Application Publication
(10) Pub. No.: US 2015/0316766 A1
(43) Pub. Date: Nov. 5, 2015

(54) Enhancing Readability on Head-Mounted Display

(71) Applicants: Joshua Weaver, San Jose, CA (US); Clifford L. Biffle, Berkeley, CA (US); Adrian Wong, Mountain View, CA (US)

(72) Inventors: Joshua Weaver, San Jose, CA (US); Clifford L. Biffle, Berkeley, CA (US); Adrian Wong, Mountain View, CA (US)

(73) Assignee: GOOGLE INC., Mountain View, CA (US)

(21) Appl. No.: 13/427,901

(22) Filed: Mar. 23, 2012

(51) Int. Cl. G09G 5/08; H04N 13/04

(52) U.S. Cl. CPC G02B 27/0172; H04N 13/0422; H04N 13/044; H04N 13/0468

(57) ABSTRACT

An embodiment takes the form of a computer-implemented method comprising causing a field-sequential color display of a wearable computing device to initially operate in a first color space; and based at least in part on data from one or more sensors of the wearable computing device, detecting movement of the wearable computing device that is characteristic of color breakup perception. The method further comprises, in response to detecting the movement that is characteristic of color breakup perception, causing the field-sequential color display to operate in a second color space.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mounted displays” (HMDs). A head-mounted display places a graphic display or displays close to one or both eyes of a wearer. To generate the images on a display, a computer processing system may be used. Such displays may occupy a wearer's entire field of view, or only occupy part of wearer's field of view. Further, head-mounted displays may be as small as a pair of glasses or as large as a helmet.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming.

### SUMMARY

In one aspect, an embodiment takes the form of a computer-implemented method comprising causing a field-sequential color display of a wearable computing device to initially operate in a first color space; and based at least in part on data from one or more sensors of the wearable computing device, detecting movement of the wearable computing device that is characteristic of color breakup perception. The method further comprises, in response to detecting the movement that is characteristic of color breakup perception, causing the field-sequential color display to operate in a second color space.

Another embodiment takes the form of a computer-implemented method comprising causing a field-sequential color display of a wearable computing device to initially operate at a first frame rate; and based at least in part on data from one or more sensors of the wearable computing device, detecting movement of the wearable computing device that is characteristic of color breakup perception. The method further comprises, in response to detecting the movement of the wearable computing device that is characteristic of color breakup perception, causing the field-sequential color display to operate at a second frame rate.

A further embodiment takes the form of a system comprising a non-transitory computer-readable medium and program instructions stored on the non-transitory computer-readable medium and executable by a processor to cause a field-sequential color display of a wearable computing device to initially operate in a first color space. The instructions are further executable to, based at least in part on data from one or more sensors of the wearable computing device, detect movement of the wearable computing device that is characteristic of color breakup perception; and in response to detecting the movement that is characteristic of color breakup perception, cause the field-sequential color display to operate in a second color space.

Still another embodiment takes the form of a system comprising a non-transitory computer-readable medium and program instructions stored on the non-transitory computer-readable medium and executable by a processor to cause a field-sequential color display of a wearable computing device to initially operate at a first frame rate. The instructions are further executable to, based at least in part on data from one or more sensors of the wearable computing device, detect movement of the wearable computing device that is characteristic of color breakup perception; and in response to detecting the movement of the wearable computing device that is characteristic of color breakup perception, cause the field-sequential color display to operate at a second frame rate.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 is a flowchart of a first method, in accordance with exemplary embodiments;

FIG. 2 is a flowchart of a second method, in accordance with exemplary embodiments;

FIG. 3 is a flowchart of a third method, in accordance with exemplary embodiments;

FIG. 4 is a flowchart of a fourth method, in accordance with exemplary embodiments;

FIG. 5 is a block diagram of a wearable device, in accordance with exemplary embodiments; and

FIGS. 6A and 6B, and 7A and 7B, respectively, depict views of a wearable computing system, in accordance with exemplary embodiments.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that aspects of the present disclosure, as generally described herein, and illustrated in the figures, can be arranged, substituted, combined, separated, and designed in a wide variety of different configurations, all of which are contemplated herein.

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

I. Overview

A wearable display may include a field-sequential color display. A field-sequential color display may rapidly present a series of successive, primary-color images that are observed as a single polychromatic image. The rate at which the display is able to cycle through each of its primary colors may be referred to as the display's frame rate. For example, to present a single polychromatic image, the display may first present a red representation of the frame, then a green representation, and then a blue representation. The display may or may not then repeat the sequence of red, green, and blue images to ensure a sufficient frame rate. One example of a field-sequential color display is a Digital Light Processing (DLP) display, which is commonly incorporated into large-screen televisions.

One drawback of field-sequential color displays is the potential for color breakup—a phenomenon more commonly referred to as the “rainbow effect.” The rainbow effect may be most apparent at the boundary between two colors (and especially between two high-contrast colors) when the speed of an image on the display is the same as a user's eyes tracking that image. For example, the rainbow effect commonly occurs on many field-sequential color displays during the scrolling closing credits of motion pictures, which often include easily-trackable white text on a black background. Those having skill in the art will recognize that other circumstances may also give rise to the rainbow effect. In such situations, the user may observe noticeable color separation.

The rainbow effect may be perceived when the field-sequential color display itself is subject to movement. For example, a wearable-display user may perceive the rainbow effect while eating crunchy food such as breakfast cereal, running, riding a bike, and/or rotating his or her head, among other examples.

Various embodiments are described for mitigating the rainbow effect when the field-sequential color display itself is subject to movement. In an exemplary embodiment, a system detects movement of the wearable computing device that is characteristic of color breakup perception (e g , running, eating, and/or other movement or vibration), and responsively causes the display to operate in a monochromatic (i.e., single color) color space. By operating in this color space, the display no longer needs to present the series of successive (e.g., red, green, blue, red, green, blue, etc.) images, a prerequisite for the rainbow effect to occur. In another embodiment, the wearable device detects a threshold amount of movement of the field-sequential color display and responsively causes the display to operate at a higher frame rate, thus mitigating color breakup effects.

II. Exemplary Method

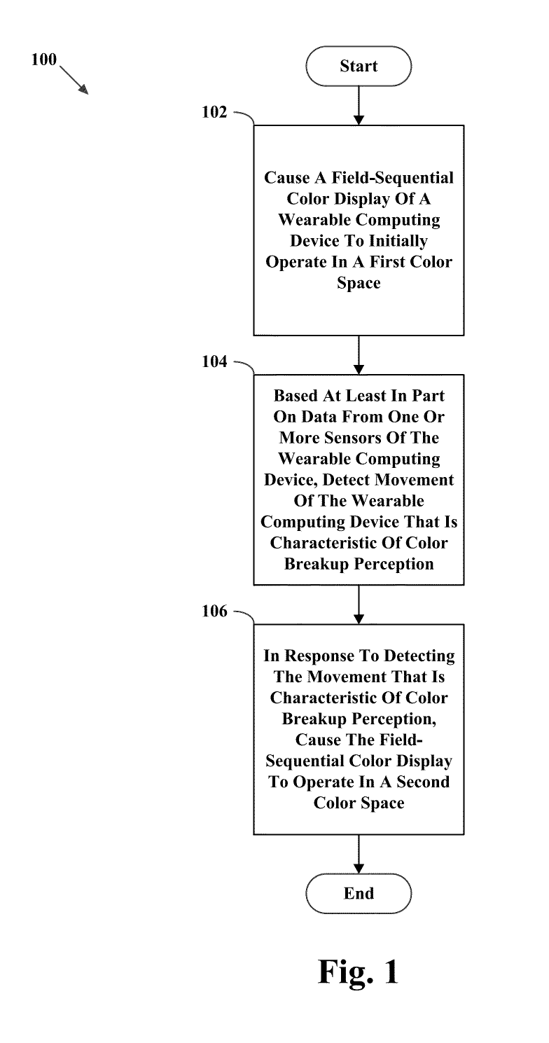

FIG. 1 is a flowchart of a first method, in accordance with exemplary embodiments. As shown in FIG. 1, method 100 begins at block 102 by causing a field-sequential color display of a wearable computing device to initially operate in a first color space. The method continues at block 104 by, based at least in part on data from one or more sensors of the wearable computing device, detecting movement of the wearable computing device that is characteristic of color breakup perception. Method 100 continues at block 106 by, in response to detecting the movement that is characteristic of color breakup perception, causing the field-sequential color display to operate in a second color space.

Detecting movement of the wearable computing device that is characteristic of color breakup perception could include, for example, detecting that a wearable-device user is running, jogging, eating, moving and/or rotating his or her head, eating crunchy food, and/or riding a bike, among other examples. On the other hand, detecting movement of the wearable computing device that is characteristic of color breakup perception may not include subtle movements such as breathing, slow walking, and/or speaking, among other possibilities. Those having skill in the art will recognize that the detected movements described here are exemplary, and that other detected movements are possible as well.

In an embodiment, the first color space is a polychromatic color space. While operating in a polychromatic color space, the field-sequential color display may rapidly cycle through successive primary colors and present monochromatic images in those primary colors that are observed as a single polychromatic image. The polychromatic color space could be a red-green-blue (RGB) color space and/or a red-green-blue-white (RGBW) color space, among other examples. The first color space could also be a monochromatic color space.

In an embodiment, the second color space is a monochromatic color space (e.g., red only, green only, blue only, etc.). While operating in a monochromatic color space, the field-sequential color display need not rapidly cycle through successive primary colors to present a monochromatic image in those primary colors, because the display would present images using only a single primary color. Thus the rainbow effect is eliminated by operating in a monochromatic color space.

In another embodiment, the second color space is a polychromatic color space. The polychromatic color space could be a red-white color space and/or a cyan-magenta-yellow color space, among other examples. Those having skill in the art will recognize that other variations to the first and second color spaces are possible without departing from the scope of the claims.

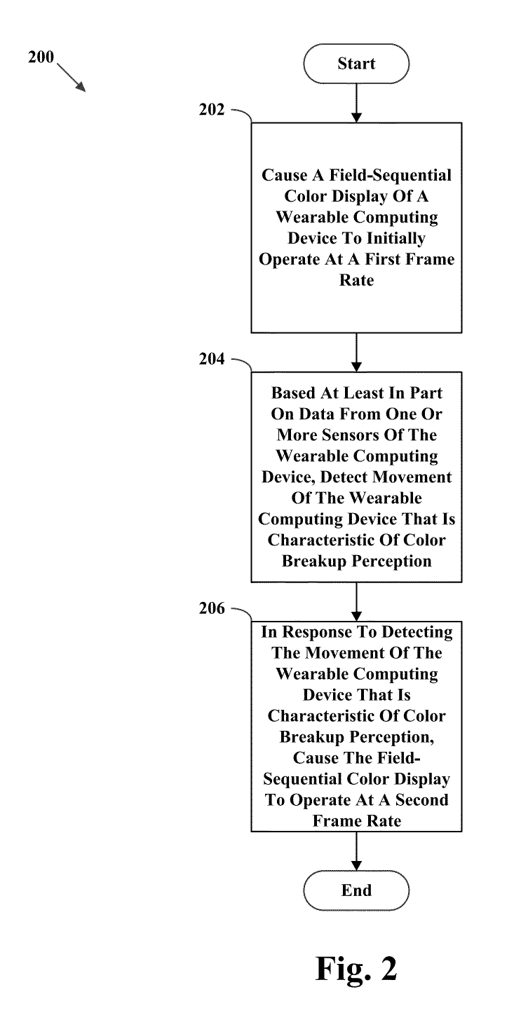

FIG. 2 is a flowchart of a second method, in accordance with exemplary embodiments. As shown in FIG. 2, method 200 begins at block 202 by causing a field-sequential color display of a wearable computing device to initially operate at a first frame rate. The method continues at block 204 by, based at least in part on data from one or more sensors of the wearable computing device, detecting movement of the wearable computing device that is characteristic of color breakup perception. Method 200 continues at block 206 by, in response to detecting the movement of the wearable computing device that is characteristic of color breakup perception, causing the field-sequential color display to operate at a second frame rate.

The first frame rate could be 60 frames per second and the second frame rate could be 120 frames per second, as examples. In an embodiment, the wearable device could detect that the wearable-device user is stationary, and responsively cause the field-sequential color display to operate at 60 frames per second. In another embodiment, the wearable device could detect that the wearable-device user is not stationary, and responsively cause the field-sequential color display to operate at 120 frames per second. Those having skill in the art will understand that other variations are possible as well.

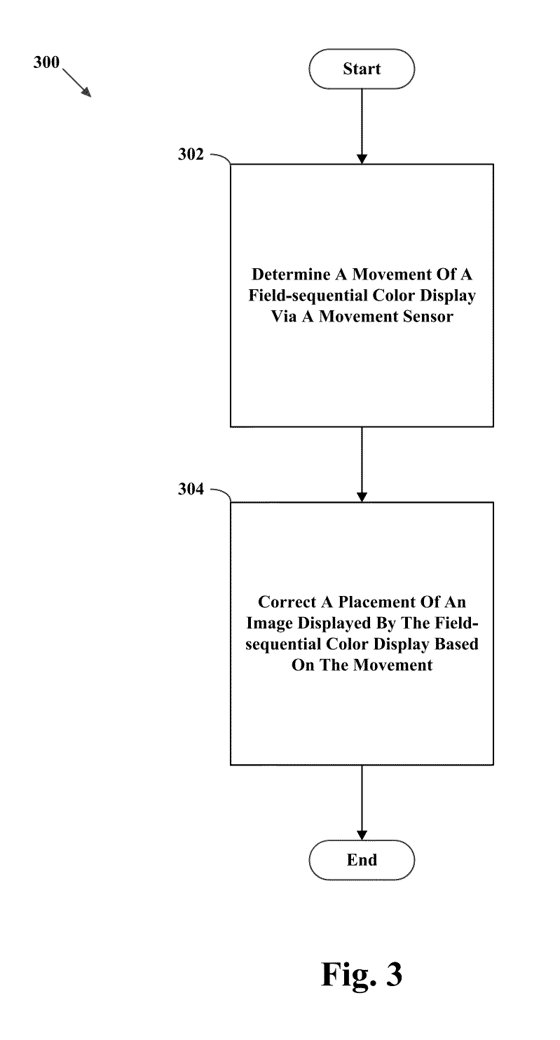

FIG. 3 is a flowchart of a third method, in accordance with exemplary embodiment. As shown in FIG. 3, method 300 begins at block 302 with a wearable device determining a movement of a field-sequential color display via a movement sensor. The method continues at block 304 with the wearable device correcting a placement of an image displayed by the field-sequential color display based on the movement. In an embodiment, correcting the placement of the image includes offsetting the image based on the movement.

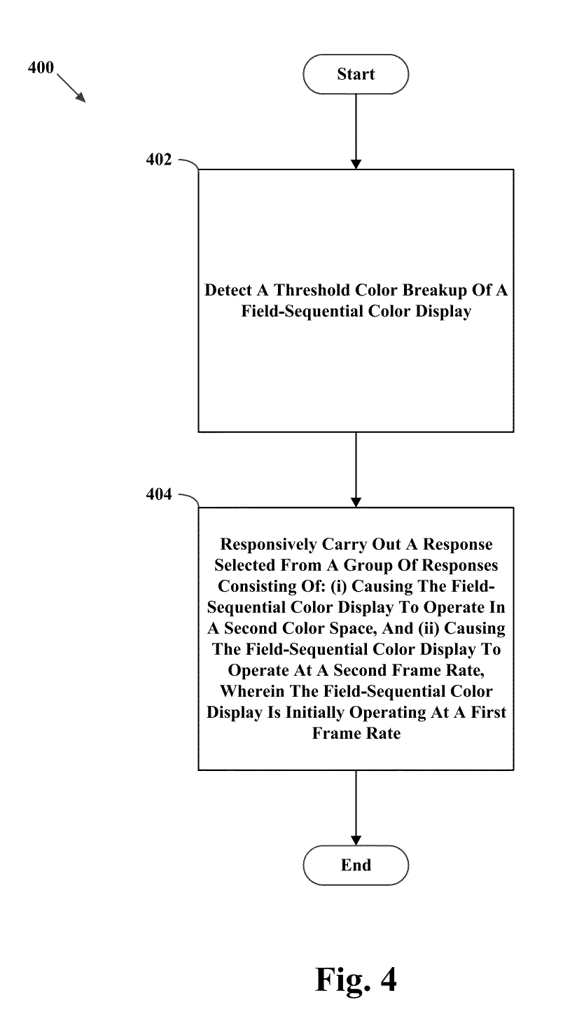

FIG. 4 is a flowchart of a fourth method, in accordance with exemplary embodiments. As shown in FIG. 4, method 400 begins at block 402 with a wearable device detecting color breakup of a field-sequential color display. Method 400 continues at block 404 with the wearable device responsively carrying out a response selected from a group of responses consisting of (i) causing the field-sequential color display to operate in a second color space and, and (ii) causing the field-sequential color display to operate at a second frame rate.

Detecting color breakup could include, for example, detecting a threshold amount of color breakup. Further, correcting the placement of the image could include offsetting the image based on the movement. Other variations are possible as well without departing from the scope of the claims.

III. Exemplary Wearable Device

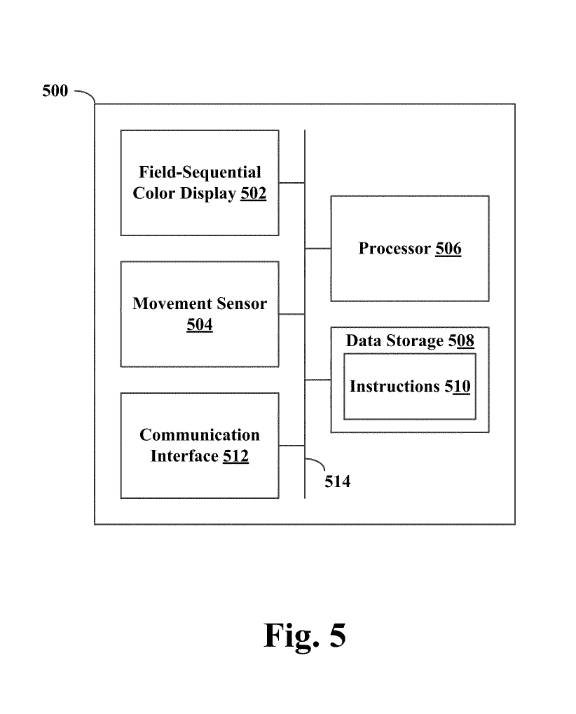

FIG. 5 is a block diagram of a wearable device, in accordance with exemplary embodiments. As shown in FIG. 5, wearable device 500 includes field-sequential color display 502, movement sensor 504, processor 506, data storage 508 storing instructions 510, and communication interface 512, all connected by communication link 514. Each described entity could take the form of hardware and/or software, and could take the form of multiple entities. Those having skill in the art will recognize that additional and/or different entities may be present as well, and that some entities need not be present at all, without departing from the scope of the claims.

Field-sequential color display 502 may take the form of a Digital Micromirror Device (DMD) display and/or a Liquid Crystal on Silicon (LCoS) display, among numerous other possibilities.

Movement sensor 504 may be entity capable of detecting movement and/or vibration. Accordingly, the movement sensor may take the form of (or include) an accelerometer (for, e.g., detecting a user eating crunchy food, etc.), a gyroscope (for, e.g., detecting head movement), and/or a nose-slide sensor, among other possibilities. The movement sensor may also be capable of distinguishing between movement and vibration. Those having skill will recognize that movement sensor 504 may take other forms as well.

Processor 506 may take the form of a general-purpose microprocessor, a discrete signal processor, a microcontroller, a system-on-a-chip, and/or any combination of these. Processor 506 may take other forms as well without departing from the scope of the claims.

Data storage 508 may store a set of machine-language instructions 510, which are executable by processor 506 to carry out various functions described herein. Additionally or alternatively, some or all of the functions could instead be implemented via hardware entities. Data storage 508 may store additional data as well, perhaps to facilitate carrying out various functions described herein. Data storage 508 may take other forms as well without departing from the scope of the claims.

Communication interface 512 may be any entity capable facilitating wired and/or wireless communication between wearable device 500 and another entity. Wired communication could take the form of universal serial bus (USB), FireWire, Ethernet, or Internet Protocol (IP) communication, or any combination of these. Wireless communication could take the form of infrared data association (IrDA), Bluetooth, ZigBee, ultra-wideband (UWB), wireless USB (WUSB), Wi-Fi, or cellular-network (e.g., mobile phone) communication, or any combination of these. Those having skill in the art will recognize that the wired and/or wireless communication could take other forms as well. Communication interface 512 may additionally or alternatively facilitate wired and/or wireless communication between entities within wearable device 500.

Communication link 514 may take the form of any wired and/or wireless communication link. As such, communication link 514 could take the form of a system bus, a USB connection, an Ethernet connection, and/or an IP connection, among other possibilities. Accordingly, the entities in wearable device 500 could be contained in a single device, and/or could be spread among multiple devices, perhaps in communication via a personal area network (PAN) and/or the Internet, among other possible variations.

Wearable device 500 could take multiple forms. As one example, the wearable device could take the form of a near-eye display, such as a head-mounted display. As another possibility, wearable device 500 could take the form of a near-eye display in communication with another computing device such as a smartphone and/or an Internet server. Wearable device 500 could also take the form a personal computer with gaze-area detecting functionality. Those having skill in the art will understand that wearable device 500 could take other forms as well.

IV. Exemplary Head-Mounted Display

Systems and devices in which exemplary embodiments may be implemented will now be described in greater detail. In general, an exemplary system may be implemented in or may take the form of a wearable computer. However, an exemplary system may also be implemented in or take the form of other devices, such as a mobile phone, among others. Further, an exemplary system may take the form of non-transitory computer readable medium, which has program instructions stored thereon that are executable by at a processor to provide the functionality described herein. An exemplary, system may also take the form of a device such as a wearable computer or mobile phone, or a subsystem of such a device, which includes such a non-transitory computer readable medium having such program instructions stored thereon.

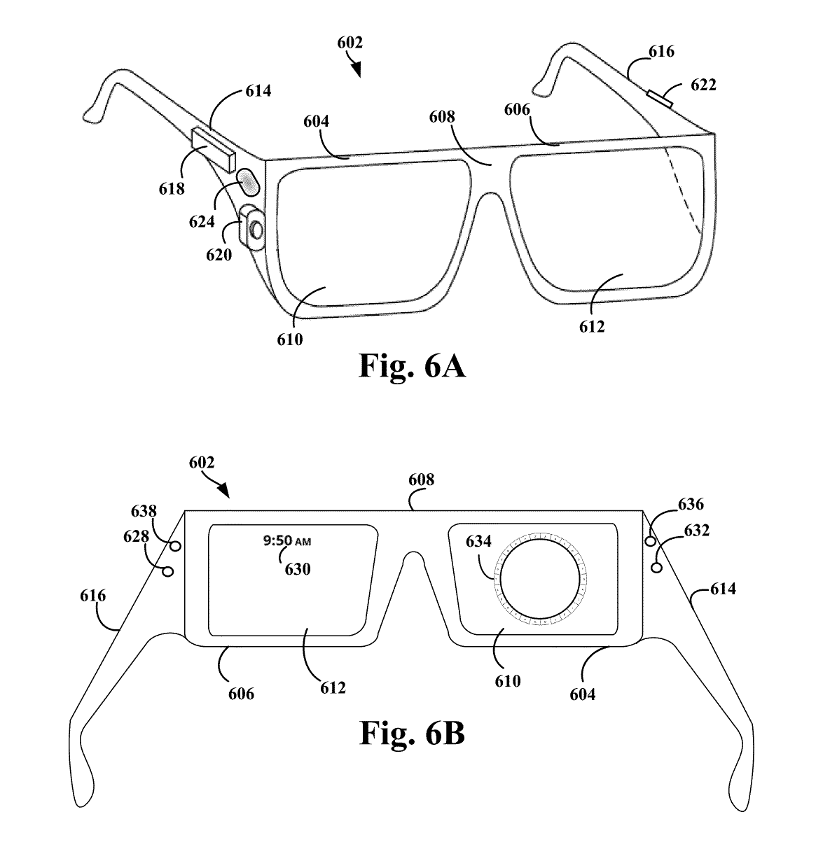

FIG. 6A illustrates a wearable computing system according to an exemplary embodiment. In FIG. 6A, the wearable computing system takes the form of a head-mounted device (HMD) 602 (which may also be referred to as a head-mounted display). It should be understood, however, that exemplary systems and devices may take the form of or be implemented within or in association with other types of devices, without departing from the scope of the invention. As illustrated in FIG. 6A, the head-mounted device 602 includes frame elements including lens-frames 604 and 606 and a center frame support 608, lens elements 610 and 610, and extending side-arms 614 and 616. The center frame support 608 and the extending side-arms 614 and 616 are configured to secure the head-mounted device 602 to a user's face via a user's nose and ears, respectively.

Each of the frame elements 604, 606, and 608 and the extending side-arms 614 and 616 may be formed of a solid structure of plastic and/or metal, or may be formed of a hollow structure of similar material so as to allow wiring and component interconnects to be internally routed through the head-mounted device 602. Other materials may be possible as well.

One or more of each of the lens elements 610 and 612 may be formed of any material that can suitably display a projected image or graphic. Each of the lens elements 610 and 612 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 614 and 616 may each be projections that extend away from the lens-frames 604 and 606, respectively, and may be positioned behind a user's ears to secure the head-mounted device 602 to the user. The extending side-arms 614 and 616 may further secure the head-mounted device 602 to the user by extending around a rear portion of the user's head. Additionally or alternatively, for example, the HMD 602 may connect to or be affixed within a head-mounted helmet structure. Other possibilities exist as well.

The HMD 602 may also include an on-board computing system 618, a video camera 620, a sensor 622, and a finger-operable touch pad 624. The on-board computing system 618 is shown to be positioned on the extending side-arm 614 of the head-mounted device 602; however, the on-board computing system 618 may be provided on other parts of the head-mounted device 602 or may be positioned remote from the head-mounted device 602 (e.g., the on-board computing system 618 could be wire-or wirelessly-connected to the head-mounted device 602). The on-board computing system 618 may include a processor and memory, for example. The on-board computing system 618 may be configured to receive and analyze data from the video camera 620 and the finger-operable touch pad 624 (and possibly from other sensory devices, user interfaces, or both) and generate images for output by the lens elements 610 and 612.

The video camera 620 is shown positioned on the extending side-arm 614 of the head-mounted device 602; however, the video camera 620 may be provided on other parts of the head-mounted device 602. The video camera 620 may be configured to capture images at various resolutions or at different frame rates. Many video cameras with a small form-factor, such as those used in cell phones or webcams, for example, may be incorporated into an example of the HMD 602.

Further, although FIG. 6A illustrates one video camera 620, more video cameras may be used, and each may be configured to capture the same view, or to capture different views. For example, the video camera 620 may be forward facing to capture at least a portion of the real-world view perceived by the user. This forward facing image captured by the video camera 620 may then be used to generate an augmented reality where computer generated images appear to interact with the real-world view perceived by the user.

The sensor 622 is shown on the extending side-arm 616 of the head-mounted device 602; however, the sensor 622 may be positioned on other parts of the head-mounted device 602. The sensor 622 may include one or more of a gyroscope or an accelerometer, for example. Other sensing devices may be included within, or in addition to, the sensor 622 or other sensing functions may be performed by the sensor 622.

The finger-operable touch pad 624 is shown on the extending side-arm 614 of the head-mounted device 602. However, the finger-operable touch pad 624 may be positioned on other parts of the head-mounted device 602. Also, more than one finger-operable touch pad may be present on the head-mounted device 602. The finger-operable touch pad 624 may be used by a user to input commands. The finger-operable touch pad 624 may sense at least one of a position and a movement of a finger via capacitive sensing, resistance sensing, or a surface acoustic wave process, among other possibilities. The finger-operable touch pad 624 may be capable of sensing finger movement in a direction parallel or planar to the pad surface, in a direction normal to the pad surface, or both, and may also be capable of sensing a level of pressure applied to the pad surface. The finger-operable touch pad 624 may be formed of one or more translucent or transparent insulating layers and one or more translucent or transparent conducting layers. Edges of the finger-operable touch pad 624 may be formed to have a raised, indented, or roughened surface, so as to provide tactile feedback to a user when the user's finger reaches the edge, or other area, of the finger-operable touch pad 624. If more than one finger-operable touch pad is present, each finger-operable touch pad may be operated independently, and may provide a different function.

FIG. 6B illustrates an alternate view of the wearable computing device illustrated in FIG. 6A. As shown in FIG. 6B, the lens elements 610 and 612 may act as display elements. The head-mounted device 602 may include a first projector 628 coupled to an inside surface of the extending side-arm 616 and configured to project a display 630 onto an inside surface of the lens element 612. Additionally or alternatively, a second projector 632 may be coupled to an inside surface of the extending side-arm 614 and configured to project a display 634 onto an inside surface of the lens element 610.

The head-mounted device 602 may also include one or more sensors coupled to an inside surface of head-mounted device 602. For example, as shown in FIG. 6B, sensor 636 coupled to an inside surface of the extending side-arm 614, and/or sensor 638 coupled to an inside surface of the extending side-arm 616. The one or more sensors could take the form of a still or video camera (such as a charge-coupled device or CCD), any of the forms discussed with reference to sensor 622, and/or numerous other forms, without departing from the scope of the claims. The one or more sensors (perhaps in coordination with one or more other entities) may be configured to perform eye tracking, such as gaze-target tracking, etc.

The lens elements 610, 612 may act as a combiner in a light projection system and may include a coating that reflects the light projected onto them from the projectors 628 and 632. In some embodiments, a reflective coating may not be used (e.g., when the projectors 628 and 632 are scanning laser devices).

In alternative embodiments, other types of display elements may also be used. For example, the lens elements 610 and 612 themselves may include a transparent or semi-transparent matrix display such as an electroluminescent display or a liquid crystal display, one or more waveguides for delivering an image to the user's eyes, and/or or other optical elements capable of delivering an in focus near-to-eye image to the user, among other possibilities. A corresponding display driver may be disposed within the frame elements 604, 606 for driving such a matrix display. Alternatively or additionally, a laser or LED source and scanning system could be used to draw a raster display directly onto the retina of one or more of the user's eyes. Other possibilities exist as well.

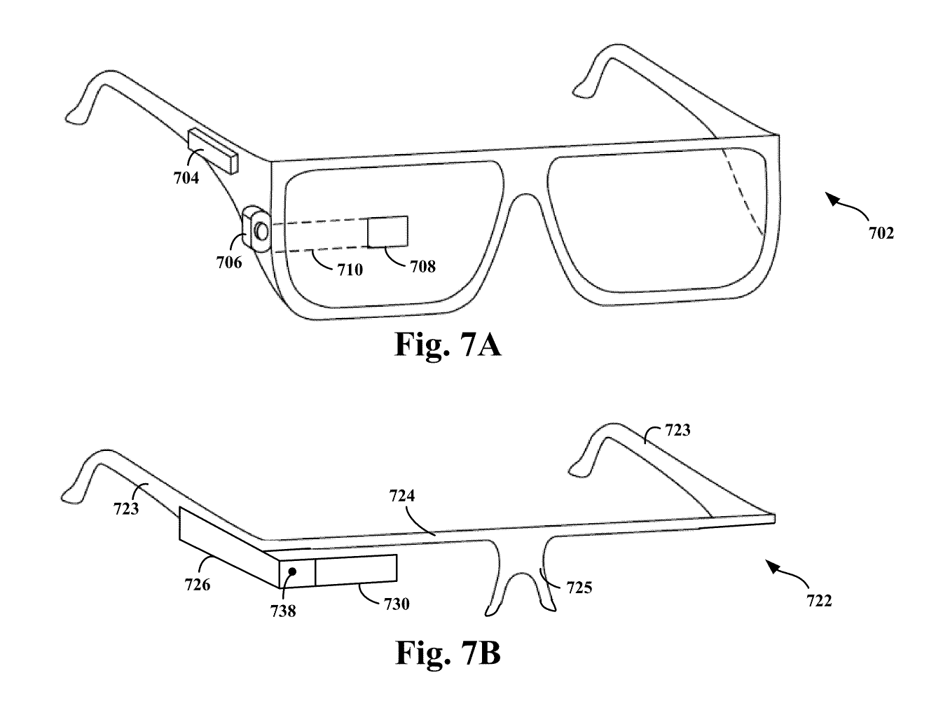

FIG. 7A illustrates another wearable computing system according to an exemplary embodiment, which takes the form of an HMD 702. The HMD 702 may include frame elements and side-arms such as those described with respect to FIGS. 6A and 6B. The HMD 702 may additionally include an on-board computing system 704 and a video camera 706, such as those described with respect to FIGS. 6A and 6B. The video camera 706 is shown mounted on a frame of the HMD 702. However, the video camera 706 may be mounted at other positions as well.

As shown in FIG. 7A, the HMD 702 may include a single display 708 which may be coupled to the device. The display 708 may be formed on one of the lens elements of the HMD 702, such as a lens element described with respect to FIGS. 6A and 6B, and may be configured to overlay computer-generated graphics in the user's view of the physical world. The display 708 is shown to be provided in a center of a lens of the HMD 702, however, the display 708 may be provided in other positions. The display 708 is controllable via the computing system 704 that is coupled to the display 708 via an optical waveguide 710.

FIG. 7B illustrates another wearable computing system according to an exemplary embodiment, which takes the form of an HMD 722. The HMD 722 may include side-arms 723, a center frame support 724, and a bridge portion with nosepiece 725. In the example shown in FIG. 7B, the center frame support 724 connects the side-arms 723. The HMD 722 does not include lens-frames containing lens elements. The HMD 722 may additionally include an onboard computing system 726 and a video camera 728, such as those described with respect to FIGS. 6A and 6B.

The HMD 722 may include a single lens element 730 that may be coupled to one of the side-arms 723 or the center frame support 724. The lens element 730 may include a display such as the display described with reference to FIGS. 6A and 6B, and may be configured to overlay computer-generated graphics upon the user's view of the physical world. In one example, the single lens element 730 may be coupled to the inner side (i.e., the side exposed to a portion of a user's head when worn by the user) of the extending side-arm 723. The single lens element 730 may be positioned in front of or proximate to a user's eye when the HMD 722 is worn by a user. For example, the single lens element 730 may be positioned below the center frame support 724, as shown in FIG. 7B.

V. Conclusion

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
causing a field-sequential color display of a wearable computing device to initially operate in a first color space;
based at least in part on data from one or more sensors of the wearable computing device, detecting movement of the wearable computing device;
determining that the movement of the wearable computing device corresponds to an identified type of persistent physical activity that is characteristic of color breakup perception within the field-sequential color display of the wearable computing device; and
in response to determining that the movement of the wearable computing device corresponds to the identified type of persistent physical activity that is characteristic of color breakup perception, causing the field-sequential color display of the wearable computing device to switch from the first color space to a second color space, wherein the second color space is chosen in order to mitigate color breakup perception resulting from operation of the wearable computing device in the first color space; and
continuing to operate the wearable computing device in the chosen second color space during the identified type of persistent physical activity.

2. The method of claim 1, wherein causing the field-sequential color display of the wearable computing device to switch from the first color space to the second color space comprises causing the field-sequential display to switch from a polychromatic color space to a monochromatic color space in order to mitigate color breakup perception resulting from operation of the wearable device in the polychromatic color space.

3. The method of claim 2, wherein the polychromatic color space comprises a red-green-blue (RGB) color space.

4. (canceled)

5. The method of claim 1, wherein the second color space is a polychromatic color space.

6. The method of claim 5, wherein the polychromatic color space is a color space selected from a group of color spaces consisting of a white-red color space and a cyan-magenta-yellow color space.

7. The method of claim 1, wherein the field-sequential color display is initially operating at a first frame rate, the method further comprising:
in further response to determining that the movement of the wearable computing device corresponds to the identified type of persistent physical activity that is characteristic of color breakup perception, causing the field-sequential color display to operate at a second frame rate.

8. The method of claim 1, wherein the movement sensor is a sensor selected from a group of sensors consisting of an accelerometer and a gyroscope.

9. A computer-implemented method comprising:
causing a field-sequential color display of a wearable computing device to initially operate at a first frame rate;
based at least in part on data from one or more sensors of the wearable computing device, detecting movement of the wearable computing device;
determining that the movement of the wearable computing device corresponds to an identified type of persistent physical activity that is characteristic of color breakup perception within the field-sequential color display of the wearable computing device;
in response to determining that the movement of the wearable computing device corresponds to the identified type of persistent physical activity that is characteristic of color breakup perception, causing the field-sequential color display of the wearable computing device to switch from the first frame rate to a second frame rate, wherein the second frame rate is chosen in order to mitigate color breakup perception resulting from operation of the wearable computing device at the first frame rate; and
continuing to operate the wearable computing device at the chosen second frame rate during the identified type of persistent physical activity.

10. A system comprising:
a non-transitory computer-readable medium; and
program instructions stored on the non-transitory computer-readable medium and executable by a processor to:
cause a field-sequential color display of a wearable computing device to initially operate in a first color space;
based at least in part on data from one or more sensors of the wearable computing device, detect movement of the wearable computing device;
determine that the movement of the wearable computing device corresponds to an identified type of persistent physical activity that is characteristic of color breakup perception within the field-sequential color display of the wearable computing device;
in response to determining that the movement of the wearable computing device corresponds to the identified type of persistent physical activity that is characteristic of color breakup perception, cause the field-sequential color display of the wearable computing device to operate in switch from the first color space to a second color space, wherein the second color space is chosen in order to mitigate color breakup perception resulting from operation of the wearable computing device in the first color space; and
continue to operate the wearable computing device in the chosen second color space during the identified type of persistent physical activity.

11. The system of claim 10, wherein the first color space is a polychromatic color space and the second color space is a monochromatic color space.

12. The system of claim 11, wherein the polychromatic color space comprises a red-green-blue (RGB) color space.

13. (canceled)

14. The system of claim 10, wherein the second color space is a polychromatic color space.

15. The system of claim 14, wherein the polychromatic color space is a color space selected from a group of color spaces consisting of a white-red color space and a cyan-magenta-yellow color space.

16. The system of claim 10, wherein the program instructions are further executable to:
cause a field-sequential color display of a wearable computing device to initially operate at a first frame rate;
cause the field-sequential color display to operate at a second frame rate in further response to determining that the movement of the wearable computing device corresponds to the identified type of persistent physical activity that is characteristic of color breakup perception.

17. The system of claim 10, wherein the movement sensor is a sensor selected from a group of sensors consisting of an accelerometer and a gyroscope.

18. A system comprising:
a non-transitory computer-readable medium; and
program instructions stored on the non-transitory computer-readable medium and executable by a processor to:
cause a field-sequential color display of a wearable computing device to initially operate at a first frame rate;
based at least in part on data from one or more sensors of the wearable computing device, detect movement of the wearable computing device;
determine that the movement of the wearable computing device corresponds to an identified type of persistent physical activity that is characteristic of color breakup perception within the field-sequential color display of the wearable computing device;
in response to determining that the movement of the wearable computing device corresponds to the identified type of persistent physical activity that is characteristic of color breakup perception, cause the field-sequential color display of the wearable computing device to switch from the first frame rate to a second frame rate, wherein the second frame rate is chosen in order to mitigate color breakup perception resulting from operation of the wearable computing device at the first frame rate; and
continue to operate the wearable computing device at the chosen second frame rate during the identified type of persistent physical activity.

19. (canceled)

20. The method of claim 1, wherein determining that the movement of the wearable computing device corresponds to the identified type of persistent physical activity that is characteristic of color breakup perception comprises detecting an amount of movement of the field-sequential color display that is greater than a threshold amount of movement.

21. The method of claim 1, wherein the identified type of persistent physical activity that is characteristic of color breakup perception comprises an athletic activity.

22. The method of claim 1, wherein the identified type of persistent physical activity that is characteristic of color breakup perception comprises at least one of running, jogging, eating, and riding a bike.

23. The method of claim 9, wherein the identified type of persistent physical activity that is characteristic of color breakup perception comprises at least one of running, jogging, eating, and riding a bike.
